(19) United States
(12) Patent Application Publication
(10) Pub. No.: US 2012/0195028 A1
(43) Pub. Date: Aug. 2, 2012

(54) Disassembly / assembly tool

(76) Inventor: Boyong Wang, Shangyu City (CN)

(21) Appl. No.: 13/337,040

(22) Filed: Dec. 23, 2011

(30) Foreign Application Priority Data
Dec. 31, 2010 (CN) 201020696807.0

(51) Int. Cl. B25B 23/18

(52) U.S. Cl. 362/119

(57) ABSTRACT

An improved disassembly/assembly tool in the technical field of machine is disclosed. The tool is characterized in that periphery of the rotating ring is covered with a hand wheel in which a luminous mechanism is fixed and a storage battery is provided in the handle. The said luminous mechanism is connected to the storage battery via an electric circuit structure. The tool has the following advantages: 1. the illumination can be realized and convenience of working is effectively increased, while not being affected by external environmental factors easily; 2. rational design, simple and compact structure, high strength, and easy for operation; 3. stable joggling portion, high operation stability, not causing locking, and long service life; 4. diverse functions. The tool not only can be used as a disassembly/assembly tool but also can be used as an electric torch under certain conditions.

### TECHNICAL FIELD OF THE INVENTION

The invention belongs to the technical field of machine, especially relates to an improved disassembly/assembly tool.

### BACKGROUND OF THE PRIOR ART

Ratchet screwdrivers are widely used in daily life. Design of the control structure of ratchet screwdrivers in existing arts is not rational enough and such technical problems as unstable transmission, inconvenient control, difficult to operate and bad structure strength exist.

To make modifications, researchers have studied for a long period and various solutions were raised. For example, a control structure of a ratchet screwdriver was disclosed in a China patent (application number 96234573.3), comprising a sleeve, a driving piece, a pushing piece and a spring. A driving rod is contained inside the sleeve and a groove is provided at surrounding of the sleeve. The driving rod is provided with a gear and the driving piece is sliding provided in the groove and two ratchet wheels in reverse directions are provided for nipping the gear. The pushing piece can push the driving piece to move along the groove. The spring can press the two ratchet wheels downwards to nip the gear, so that the actions of forward and backward rotation of the gear and the driving rod can be controlled when the two ratchet wheels nip the gear respectively and the gear and the driving rod can be locked to not make action when the two ratchet wheels nip the gear simultaneously. In addition, a ratchet screwdriver and the ratchet wheel device thereof were also disclosed [application number: 200810121667.1]. The device comprises a ratchet wheel base, an external closing ring, pawl base and two pawls. The ratchet wheel base is coated on the pawl base and the inner ring of the ratchet wheel base is provided with ratchets joggling with the pawls. Hinge joint grooves are provided on side walls at two sides of the pawl base respectively and the two pawls are hinged into the hinge joint grooves respectively, and an offsetting spring making the pawls open towards two dies to keep joggling with the ratchets. The external closing ring is coated at outside of the two ratchets and the inner ring of the external closing ring is provided with an arc-shape notch. The external ends of the two pawls are contained inside the arc-shape notch which has two flanges. When the external closing ring is rotated towards one side, one of the flanges presses inwardly one of the pawls so that the pawl is separated from the ratchet. The above proposal solves parts of problems existing in existing techniques, but the following technical problems still exist: 1. the tool can not be connected accurately when working in environments with bad light, so it has large operation difficulties and inconvenient use; 2. there exist technical problems such as complex structure, inconvenient operation and not high strength.

### OBJECTS AND DETAILED DESCRIPTION OF THE INVENTION

Aiming at the above said problems, an object of the invention is to provide an improved disassembly/assembly tool with rational design and simple structure which can realize illumination, effectively increase operation convenience and are not affected by external environmental factors easily.

To realize the above said object, the following technical solution is adopted in the invention: an improved disassembly/assembly tool comprises a handle, at the front of which a tubular base body is provided. The front end of the base body is inserted inside rear end of a tubular disassembly/assembly base and a disassembly/assembly structure which can match with working pieces is provided at front end of the disassembly/assembly base. Inner wall of the rear end of the disassembly/assembly base is provided with an annular gear formed by surrounding of several teeth. Periphery of the said base body is also covered with a rotating ring on which a joggling piece revolving with the rotating ring under driving of the rotating ring is provided. A window is provided at side portion of the base body in which a linkage mechanism which can drive the joggling piece to rotate for a certain angle and make front end of the joggling piece to joggle with the annular gear on the disassembly/assembly base when the rotating ring rotates. In addition, when the joggling piece joggles with the annular gear and the said rotating ring rotates continuously, the said disassembly/assembly base can rotate with the rotating ring, wherein: periphery of the said rotating ring is covered with a hand wheel in which a luminous mechanism is fixed and a storage battery is provided in the handle. The said luminous mechanism is connected to the storage battery via an electric circuit structure.

In the above improved disassembly/assembly tool, the said electric circuit structure comprises a lead between the luminous mechanism and the storage battery and a control switch provided on the handle is serially connected on the lead.

In the above improved disassembly/assembly tool, rear end of the handle is provided with an accommodation opening for accommodating the storage battery and a rear end cover is connected to the accommodation opening via a removable structure. A pressure spring is also provided inside the accommodation opening. One end of the said pressure spring acts on the storage battery and the other acts on the rear end cover.

In the above improved disassembly/assembly tool, the said luminous mechanism comprises an annular base on which several luminous bodies are fixed.

In the above improved disassembly/assembly tool, front end of the said hand wheel is provided with a front end cover via a removable structure. A locating ring pressed by the front end cover is provided in the hand wheel and several locating holes are provided on the locating ring. The said luminous bodies correspond with the locating holes and the luminous bodies are provided in the locating holes.

In the above improved disassembly/assembly tool, inner side of the said front end cover is provided with annular transparent lenses which are pressed on the locating ring by the front end cover.

In the above improved disassembly/assembly tool, the said linkage mechanism comprises a pillow shape body and two springs; the said pillow shape body is located in the window and two ends thereof are pressed on both sides of the joggling piece, respectively; the two springs are located at two sides of the pillow shape body, respectively; moreover, one end of the above said two springs acts on the base body and the other end acts on end portion of the pillow shape body.

In the above said disassembly/assembly tool, the said joggling piece is provided with a tegular portion at outer side of the window and a joggling portion extending to inside of the disassembly/assembly base; the said tegular portion arches outwards; a lug is provided at outside of the tegular portion and an accommodation hole for accommodating the said lug is provided on the inner wall of the rotating ring.

In the above said disassembly/assembly tool, middle portion of the said pillow shape body is depressed and the outer two sides are provided with a first contact slope respectively. The inner two sides of the said tegular portion are provided with a second contact slope respectively. The said first contact slopes correspond with the second contact slopes one by one and are close together.

In the above said disassembly/assembly tool, the inner two sides of the said pillow shape body are provided with a third slope inclining inwards, respectively. The above said two springs act on the two third slopes respectively. Two spring holes are provided on the said base body and one of the above said springs is installed in every spring hole, respectively.

Compared to existing techniques, the improved disassembly/assembly tool has the following advantages: 1. the tool can realize illumination and effectively increase convenience of working, not being affected by external environmental factors easily; 2. rational design, simple and compact structure, high strength, and easy for operation; 3. stable joggling portion, high operation stability, not causing locking, and long service life; 4. diverse functions. The tool not only can be used as a disassembly/assembly tool but also can be used as an electric torch under certain situations.

### BRIEF DRAWINGS OF THE INVENTION

FIG. 1 is a 3D view according to the invention.

FIG. 2 is the explosion view according to the invention.

FIG. 3 is the explosion view of parts of structures according to the invention.

FIG. 4 is the side structural view according to the invention.

In these figures, handle 1, base body 2, window 21, spring hole 22, disassembly/assembly base 3, disassembly/assembly structure 31, annular gear 32, rotating ring 4, accommodation hole 41, joggling piece 5, tegular portion 51, the second contact slope 51a, lug 511, joggling portion 52, hand wheel 6, luminous device 7, annular base 71, luminous body 72, storage battery 8, lead 9, control switch 10, accommodation opening 11, rear end cover 12, pressure spring 13, front end cover 14, locating ring 15, locating hole 151, transparent lens 16, pillow shape body 17, the first contact slope 17a, the third slope 17b, spring 18.

### PREFERRED EMBODIMENTS OF THE INVENTION

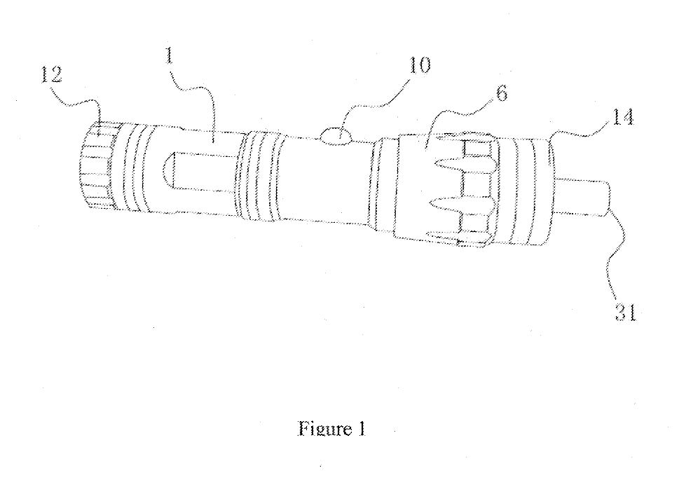

As shown in FIGS. 1-4, the improved disassembly/assembly tool comprises a handle 1, at the front of which a tubular base body 2 is provided. The front end of the base body 2 is inserted at rear end of a tubular disassembly/assembly base 3 and a disassembly/assembly structure 31 which can match with working pieces is provided at front end of the disassembly/assembly base 3. Inner wall of the rear end of the disassembly/assembly base 3 is provided with an annular gear 32 formed by surrounding of several teeth. Periphery of the said base body 2 is also covered with a rotating ring 4 on which a joggling piece 5 revolving with the rotating ring 4 under driving of the rotating ring 4 is provided. A window 21 is provided at side portion of the base body 2 in which a linkage mechanism which can drive the joggling piece 5 to rotate for a certain angle and make front end of the joggling piece 5 to joggle with the annular gear 32 on the disassembly/assembly base 3 when the rotating ring 4 rotates. In addition, when the joggling piece 5 joggles with the annular gear 32 and the said rotating ring 4 rotates continuously, the said disassembly/assembly base 3 can rotate with the rotating ring 4. Periphery of the said rotating ring 4 is covered with a hand wheel 6 in which a luminous mechanism 7 is fixed and a storage battery 8 is provided in the handle. The said luminous mechanism 7 is connected to the storage battery 8 via an electric circuit structure. Because the disassembly/assembly structure 31 can connect with the working piece to be disassembled/assembled, action of the working piece can be driven to realize disassembly/assembly of the working piece. As the luminous mechanism 7 is provided, illumination during working can be realized, which effectively increase convenience of working and is not affected by external environmental factors easily. In addition, due to its diverse functions, the tool not only can be used as a disassembly/assembly tool, but also can be used as an electric torch under certain situations.

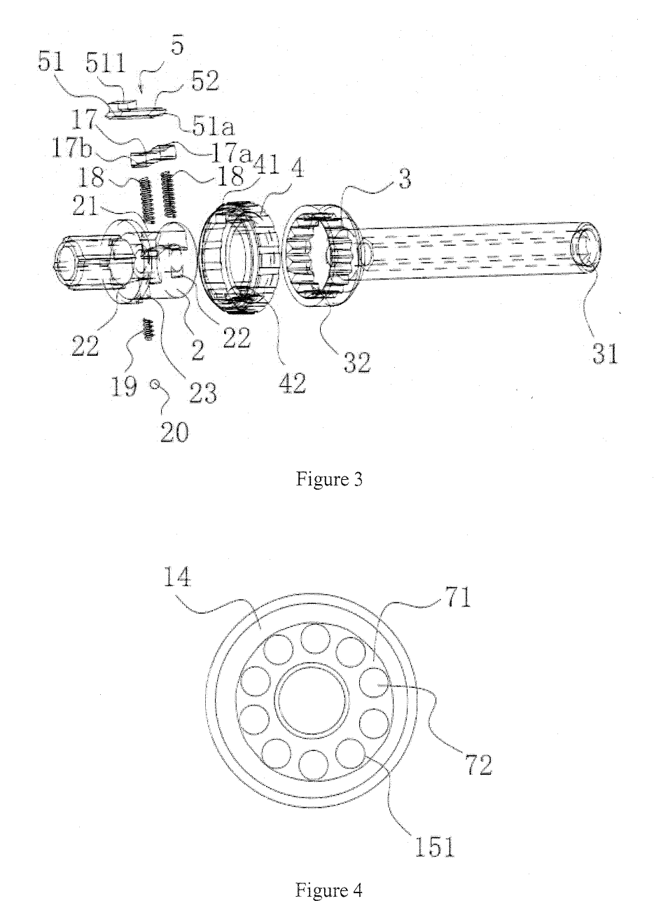

As shown in FIG. 3, the said linkage mechanism comprises a pillow shape body 17 and two springs 18. The said pillow shape body 18 is located in the window 21 and two ends thereof are pressed on both sides of the joggling piece 5, respectively. The above two springs 18 are located at two sides of the pillow shape body 17, respectively; moreover, one end of the above said two springs 18 acts on the base body 2 and the other end acts on end portion of the pillow shape body 17. The said joggling piece 5 is provided with a tegular portion 51 at outer side of the window 21 and a joggling portion 52 extending to inside of the disassembly/assembly base 3; the tegular portion 51 arches outwards; a lug 511 is provided at outside of the tegular portion 51 and an accommodation hole 41 for accommodating the said lug 511 is provided on the inner wall of the rotating ring 4. Middle portion of the said pillow shape body 17 is depressed and the outer two sides are provided with a first contact slope 17a respectively. The inner two sides of the said tegular portion 51 are provided with a second contact slope 51a respectively. The said first contact slopes 17a correspond with the second contact slopes 51a one by one and are close together. The inner two sides of the said pillow shape body 17 are provided with a third slope 17b inclining inwards, respectively. Two springs 18 act on the two third slopes 17b, respectively. Two spring holes 22 are provided on the said base body 2 and one of the above said springs 18 is installed in every spring hole 22, respectively. When the joggling portion 52 of the joggling piece joggles with the annular gear 32 and the said rotating ring 4 rotates continuously, the said disassembly/assembly base 3 can rotate together with the rotating ring 4.

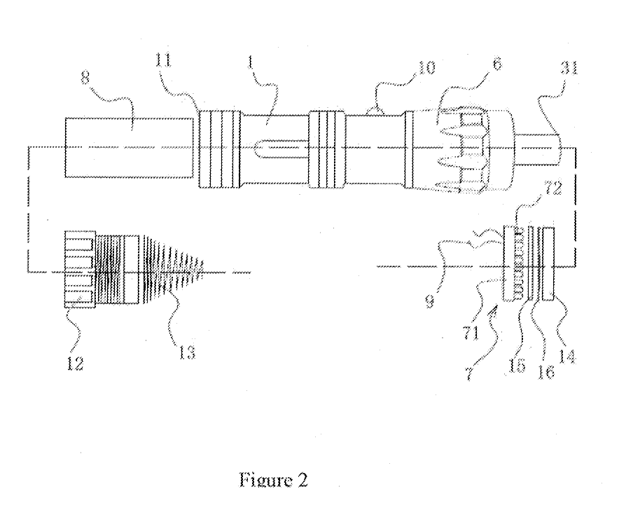

As shown in FIG. 2 and FIG. 4, the said electric circuit structure comprises a lead 9 between the luminous mechanism 7 and the storage battery 8 and a control switch 10 provided on the handle 1 is serially connected on the lead 9. Rear end of the handle 1 is provided with an accommodation opening 11 for accommodating the storage battery 8 and a rear end cover 12 is connected to the accommodation opening 11 via a removable structure. A pressure spring 13 is also provided inside the accommodation opening 11. One end of the said pressure spring 13 acts on the storage battery 8 and the other acts on the rear end cover 12. The said luminous mechanism 7 comprises an annular base 71 on which several luminous bodies 72 are fixed. Front end of the said hand wheel 6 is provided with a front end cover 14 via a removable structure. A locating ring 15 pressed by the front end cover 14 is provided in the hand wheel 6 and several locating holes 151 are provided on the locating ring 15. The said luminous bodies 72 correspond with the locating holes 151 and the luminous bodies 72 are provided in the locating holes 151. Inner side of the said front end cover 14 is provided with annular transparent lenses 16 which are pressed on the locating ring 15 by the front end cover 14.

A locating structure is also provided between the base body 2 and the rotating ring 4. The locating structure comprises a pressure spring 19 and steel balls 20. The said pressure spring 19 is installed in the pressure spring hole 23 provided on outer wall of the base body 2; a notch 42 is provided on inner wall of the rotating ring 4 and the pressure spring 19 presses the steel ball 20 in the notch 42. Working processes of the invention are as following:

When the rotating ring 4 doesn't rotate, both the pillow shape body and the joggling piece 5 are in equilibrium state and compression extents of the two springs 18 are identical. At this moment, the joggling portion 52 at front end of the joggling piece 5 is disconnected from the annular gear 32.

When the hand wheel 6 drives the rotating ring 4 to rotate toward one direction, equilibrium between the pillow shape body 17 and the joggling piece 5 is broken. Under action of the springs 18, the pillow shape body inclines gradually by taking one side thereof as the pivot, driving the joggling piece 5 to incline by taking the side as the pivot to realize rotate. At this moment, the joggling portion 52 at front end of the joggling piece 5 can joggle with the annular gear 32. Then the rotating ring 4 can drive the disassembly/assembly base to rotate. As the first contact slopes 17a and the second contact slopes 51a are provided, matching between the pillow shape body and the tegular portion 51 becomes closer and more stable, so no slipping will be caused. Because the third slopes 17b can generate a slantways inward force on the springs 18, the springs will not slip from the pillow shape body and the pillow shape body will also not slip from the tegular portion 51.

When the rotating ring 4 rotate reversely, the pillow shape body 17 inclines gradually by taking the other side thereof as the pivot to drive the joggling piece 5 to incline by taking the side as the pivot, realizing rotate. At this moment, the joggling portion 52 at front end of the joggling piece 5 can also joggle with the annular gear 32. The working processes are similar to those in forward rotation.

Obviously, when rotation direction of the rotating ring 4 in the invention is changed, both rotation direction and rotating pivot of the pillow shape body 17 are different from those of the joggling piece 5.

The preferred embodiments described in the specification are only illustrations for spirits of the invention. Those skilled in the art of the invention will appreciate the present utility model may be susceptible to variations and modifications other than those specifically described. It is also understood that the present invention encompasses all such variations and modifications that fall within spirits of the invention and scope defined in claims.

Although such glossaries as handle 1, base body 2, window 21, spring hole 22, disassembly/assembly base 3, disassembly/assembly structure 31, annular gear 32, rotating ring 4, accommodation hole 41, joggling piece 5, tegular portion 51, the second contact slope 51a, lug 511, joggling portion 52, hand wheel 6, luminous device 7, annular base 71, luminous body 72, storage battery 8, lead 9, control switch 10, accommodation opening 11, rear end cover 12, pressure spring 13, front end cover 14, locating ring 15, locating hole 151, transparent lens 16, pillow shape body 17, the first contact slope 17a, the third slope 17b and spring 18 are used in the specification frequently, the possibility of using other glossaries should not be excluded. The object of using these glossaries is only to describe and explain the nature of the present invention more conveniently and explanation of these glossaries into any one additional limitation is disobedient with the spirits of the present invention.

1. An improved disassembly/assembly tool comprises a handle (1), at the front of which a tubular base body (2) is located, the front end of the base body (2) is inserted into the rear end of a tubular disassembly/assembly base (3) and a disassembly/assembly structure (31) which can match with working pieces is provided at the front end of disassembly/assembly base (3), and inner wall of the rear end of the disassembly/assembly base (3) is provided with an annular gear (32) formed by surrounding of several teeth; and periphery of the said base body (2) is also covered with a rotating ring (4), on which a joggling piece (5) revolving with the rotating ring (4) under driving of the rotating ring (4) is provided; a window (21) is arranged at side portion of the base body (2) in which a linkage mechanism which can drive the joggling piece (5) to rotate for a certain angle and make the front end of joggling piece (5) to joggle with the annular gear (32) on the disassembly/assembly base (3) when the rotating ring (4) rotates; when the joggling piece (5) joggles with the annular gear (32) and the said rotating ring (4) rotates continuously, the said disassembly/assembly base (3) can rotate with the rotating ring (4), wherein periphery of the said rotating ring (4) is covered with a hand wheel (6), in which a luminous mechanism (7) is fixed and a storage battery (8) is set inside the handle; the said luminous mechanism (7) is connected to the storage battery (8) via an electric circuit structure.

2. The improved disassembly/assembly tool as claimed in claim 1, wherein the said electric circuit structure comprises a lead (9) between the luminous mechanism (7) and the storage battery (8) and a control switch (10) provided on the handle (1) is serially connected on the lead (9).

3. The improved disassembly/assembly tool as claimed in claim 2 wherein rear end of the handle (1) is provided with an accommodation opening (11) for accommodating the storage battery (8) and a rear end cover (12) is connected to the accommodation opening (11) via a removable structure; and a pressure spring (13) is also mounted inside the accommodation opening (11), and one end of the said pressure spring (13) acts on the storage battery (8) and the other acts on the rear end cover (12).

4. The improved disassembly/assembly tool as claimed in claim 1, claim 2 or claim 3, wherein the said luminous mechanism (7) comprises an annular base (71), on which several luminous bodies (72) are fixed.

5. The improved disassembly/assembly tool as claimed in claim 4 wherein front end of the said hand wheel (6) is provided with a front end cover (14) via a removable structure; and a locating ring (15) pressed by the front end cover (14) is arranged inside the hand wheel (6) and several locating holes (151) are set on the locating ring (15), the said luminous bodies (72) correspond with the locating holes (151) and the luminous bodies (72) are provided in the locating holes (151).

6. The improved disassembly/assembly tool as claimed in claim 5 wherein inner side of the said front end cover (14) is provided with annular transparent lenses (16) which are pressed on the locating ring (15) by the front end cover (14).

7. The improved disassembly/assembly tool as claimed in claim 4 wherein the said linkage mechanism comprises a pillow shape body (17) and two springs (18); the said pillow shape body (17) is located in the window (21) and two ends thereof are pressed on both sides of the joggling piece (5), respectively; the two springs (18) are located at two sides of the pillow shape body (17), respectively; and one end of the above said two springs (18) acts on the base body (2) and the other end acts on end portion of the pillow shape body (17).

8. The improved disassembly/assembly tool as claimed in claim 7 wherein the said joggling piece (5) is provided with a tegular portion (51) at an outer side of the window (21) and a joggling portion (52) extending to inside of the disassembly/assembly base (3); the said tegular portion (51) arches outwards; a lug (511) is arranged at outside of the tegular portion (51) and an accommodation hole (41) for accommodating the said lug (511) is mounted on the inner wall of the rotating ring (4).

9. The improved disassembly/assembly tool as claimed in claim 8 wherein middle portion of the said pillow shape body (17) is depressed and the outer two sides are provided with a first contact slope (17a) respectively, two inner sides of the said tegular portion (51) are provided with a second contact slope (51a) respectively; the said first contact slopes (17a) correspond with the second contact slopes (51a) one by one and are close together.

10. The improved disassembly/assembly tool as claimed in claim 9 wherein two inner sides of the said pillow shape body (17) are provided with a third slope (17b) inclining inwards, respectively; and the above said two springs (18) act on the two third slopes (17b) respectively; two spring holes (22) are provided on the said base body (2) and one of the above said springs (18) is installed in every spring hole (22), respectively.
